(19) United States
(12) Patent Application Publication
(10) Pub. No.: US 2024/0119057 A1
(43) Pub. Date: Apr. 11, 2024

(54) MACHINE LEARNING TECHNIQUES FOR GENERATING CROSS-TEMPORAL SEARCH RESULT PREDICTION

(71) Applicant: UnitedHealth Group Incorporated, Minnetonka, MN (US)

(72) Inventors: Cem Unsal, Alameda, CA (US); Gregory D. Lyng, Minneapolis, MN (US); Irfan Bulu, Sartell, MN (US)

(21) Appl. No.: 17/938,575

(22) Filed: Oct. 6, 2022

(51) Int. Cl. G06F 16/2457; G06F 16/2458

(52) U.S. Cl. CPC G06F 16/24578; G06F 16/2465

(57) ABSTRACT

Various embodiments of the present invention provide methods, apparatus, systems, computing devices, computing entities, and/or the like for performing cross-temporal search result predictions. Certain embodiments of the present invention utilize systems, methods, and computer program products that perform cross-temporal search result predictions using a multimodal hierarchical attention machine learning framework.

### BACKGROUND

Various embodiments of the present invention address technical challenges related to performing cross-temporal search result predictions and disclose innovative techniques for efficiently and effectively performing cross-temporal search predictions.

### BRIEF SUMMARY

In general, various embodiments of the present invention provide methods, apparatus, systems, computing devices, computing entities, and/or the like for performing cross-temporal search result prediction for a predictive entity. Certain embodiments of the present invention utilize systems, methods, and computer program products that perform cross-temporal search result predictions utilizing a multimodal hierarchical attention machine learning framework.

In accordance with one aspect, a method is provided. In one embodiment, the method comprises: identifying a current input document and a plurality of historical input documents associated with the predictive entity, wherein each historical input document comprises a plurality of per-modality segments for a plurality of historical input modalities; generating a historical input embedding for the predictive entity based at least in part on the plurality of historical input documents, wherein: (i) the historical input embedding is generated based at least in part on a plurality of per-document historical input embeddings for the plurality of historical input documents, and (ii) generating a respective per-document historical input embedding for a particular historical input document comprises: for each historical input modality, generating, based at least in part on each input token that is associated with the historical input modality and using a per-modality cross-token attention machine learning model for the historical input modality, a modality representation, and generating, based at least in part on each modality representation and using a cross-modality attention machine learning model, the respective per-document historical input embedding; generating, based at least in part on the historical input embedding, a current input embedding for the historical input embedding, and a plurality of referential embeddings for a plurality of reference documents, the cross-temporal search result prediction; and performing one or more prediction-based actions based at least in part on the cross-temporal search result prediction.

In accordance with another aspect, a computer program product is provided. The computer program product may comprise at least one computer-readable storage medium having computer-readable program code portions stored therein, the computer-readable program code portions comprising executable portions configured to: identify a current input document and a plurality of historical input documents associated with the predictive entity, wherein each historical input document comprises a plurality of per-modality segments for a plurality of historical input modalities; generate a historical input embedding for the predictive entity based at least in part on the plurality of historical input documents, wherein: (i) the historical input embedding is generated based at least in part on a plurality of per-document historical input embeddings for the plurality of historical input documents, and (ii) generating a respective per-document historical input embedding for a particular historical input document comprises: for each historical input modality, generating, based at least in part on each input token that is associated with the historical input modality and using a per-modality cross-token attention machine learning model for the historical input modality, a modality representation, and generating, based at least in part on each modality representation and using a cross-modality attention machine learning model, the respective per-document historical input embedding; generate, based at least in part on the historical input embedding, a current input embedding for the historical input embedding, and a plurality of referential embeddings for a plurality of reference documents, the cross-temporal search result prediction; and perform one or more prediction-based actions based at least in part on the cross-temporal search result prediction.

In accordance with yet another aspect, an apparatus comprising at least one processor and at least one memory including computer program code is provided. In one embodiment, the at least one memory and the computer program code may be configured to, with the processor, cause the apparatus to: identify a current input document and a plurality of historical input documents associated with the predictive entity, wherein each historical input document comprises a plurality of per-modality segments for a plurality of historical input modalities; generate a historical input embedding for the predictive entity based at least in part on the plurality of historical input documents, wherein: (i) the historical input embedding is generated based at least in part on a plurality of per-document historical input embeddings for the plurality of historical input documents, and (ii) generating a respective per-document historical input embedding for a particular historical input document comprises: for each historical input modality, generating, based at least in part on each input token that is associated with the historical input modality and using a per-modality cross-token attention machine learning model for the historical input modality, a modality representation, and generating, based at least in part on each modality representation and using a cross-modality attention machine learning model, the respective per-document historical input embedding; generate, based at least in part on the historical input embedding, a current input embedding for the historical input embedding, and a plurality of referential embeddings for a plurality of reference documents, the cross-temporal search result prediction; and perform one or more prediction-based actions based at least in part on the cross-temporal search result prediction.

### BRIEF DESCRIPTION OF THE SEVERAL VIEWS OF THE DRAWINGS

Reference will now be made to the accompanying drawings, which are not necessarily drawn to scale, and wherein:

FIG. 1 provides an exemplary overview of an architecture that can be used to practice embodiments of the present invention.

FIG. 2 provides an example predictive data analysis computing entity in accordance with some embodiments discussed herein.

FIG. 3 provides an example external computing entity in accordance with some embodiments discussed herein.

FIG. 4 provides a flowchart diagram of an example process for generating a cross-temporal search result prediction for a predictive entity in accordance with some embodiments discussed herein.

FIG. 5 provides a flowchart diagram of an example process for generating a per-document historical input embedding in accordance with some embodiments discussed herein.

FIG. 6 provides a flowchart diagram of an example process for generating a historical input embedding with respect to a predictive entity in accordance with some embodiments discussed herein.

FIG. 7 provides a flowchart diagram of an example process for generating a plurality of referential embeddings in accordance with some embodiments discussed herein.

FIG. 8 provides a flowchart diagram of an example process for generating a cross-temporal search result prediction based at least in part on cross-temporal input embedding and per-section referential embeddings in accordance with some embodiments discussed herein.

FIG. 9 provides an operational example of a prediction output user interface in accordance with some embodiments discussed herein.

### DETAILED DESCRIPTION

Various embodiments of the present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to cross-temporal search result prediction in a clinical guideline search context, one of ordinary skill in the art will recognize that the disclosed concepts can be used to perform other types of cross-temporal search result prediction. For example, the disclosed concepts can be used to perform any search in which relevant section and/or subsections of documents are selected based at least in part on text data entered in real-time, past temporal or sequenced text data, and/or document text.

### I. OVERVIEW AND TECHNICAL ADVANTAGES

Various embodiments of the present disclosure make important technical contributions to improving predictive accuracy of search result generation machine learning models that operate on multi-modality input data by using cross-modality attention machine learning models as part of the encoding mechanism of the noted search result generation machine learning models, an improvement which in turn enhances training speed and training efficiency of machine learning models. It is well-understood in the relevant art that there is typically a tradeoff between predictive accuracy and training speed, such that it is trivial to improve training speed by reducing predictive accuracy, and thus the real challenge is to improve training speed without sacrificing predictive accuracy through innovative model architectures, see, e.g., Sun et al., Feature-Frequency—Adaptive On-line Training for Fast and Accurate Natural Language Processing in 40(3) Computational Linguistic 563 at Abst. (“Typically, we need to make a tradeoff between speed and accuracy. It is trivial to improve the training speed via sacrificing accuracy or to improve the accuracy via sacrificing speed. Nevertheless, it is nontrivial to improve the training speed and the accuracy at the same time”). Accordingly, the techniques described herein improve predictive accuracy without harming training speed, such as various techniques described herein, enable improving training speed given a constant predictive accuracy. In doing so, the techniques described herein improve accuracy, efficiency, and speed of search result generation machine learning models, thus reducing the number of computational operations needed and/or the amount of training data entries needed to train search result generation machine learning models. Accordingly, the techniques described herein improve at least one of the computational efficiency, storage-wise efficiency, and speed of training search result generation machine learning models.

Moreover, various embodiments of the present disclosure enable practical applications related to performing operational load balancing for post-prediction systems by using cross-temporal search result classifications generated based at least in part on cross-temporal search result predictions to determine an optimal number of computing entities needed to perform the noted post-processing operations. For example, in some embodiments, a predictive data analysis computing entity determines L cross-temporal search result classifications for L predictive entities based at least in part on the cross-temporal search result predictions for the predictive entities. Then, the count of predictive entities that are associated with affirmative cross-temporal search result classifications, along with a resource utilization ratio for each predictive entity, can be used to predict a predicted number of computing entities needed to perform post-prediction processing operations (e.g., automated investigation operations) with respect to the L predictive entities. For example, in some embodiments, the number of computing entities needed to perform post-prediction processing operations (e.g., automated investigation operations) with respect to the L predictive entities can be determined based at least in part on the output of the equation: R=ceil(Σₖ^{k=K}urₖ), where R is the predicted number of computing entities needed to perform post-prediction processing operations with respect to the L predictive entities, cell(⋅) is a ceiling function that returns the closest integer that is greater than or equal to the value provided as the input parameter of the ceiling function, k is an index variable that iterates over K predictive entities among the L predictive entities that are associated with affirmative cross-temporal search result classifications, and urₖ is the estimated resource utilization ratio for a kth predictive entity that may be determined based at least in part on an input batch size associated with the kth predictive entity. In some embodiments, once R is generated, the predictive data analysis computing entity can use R to perform operational load balancing for a server system that is configured to perform post-prediction processing operations (e.g., automated investigation operations) with respect to the L predictive entities. This may be done by allocating computing entities to the post-prediction processing operations if the number of currently-allocated computing entities is below R, and deallocating currently-allocated computing entities if the number of currently-allocated computing entities is above R.

In some embodiments, a machine learning-based system for determining relevant clinical document sections (i.e., guidelines) for a medical provider in real-time by utilizing a hierarchical framework is configured to: (i) generate a query vector based at least in part on a real-time provider notes vector representation and a historical medical records vector representation, (ii) determine, based at least in part on a document similarity measure for each document vector representation of a plurality of document vector representations with respect to the query vector, a subset of document vector representations, where each document vector representation is associated with one or more document section vector representations; (iii) for each document section vector representation associated with the subset of document vector representations, determine a document section similarity measure with respect to the query vector; and (iv) determine one or more document sections corresponding to a threshold-satisfying document section similarity measure.

An exemplary application of various embodiments of the present invention relates to dynamically providing, to a provider during a patient visit, the relevant guidelines for the patient encounter based at least in part on the provider's notes during the visit and the patient's medical history. In some embodiments, clinical guidelines are systematically developed statements designed to assist practitioners make decisions in specific clinical circumstances. However, as guidelines proliferate and are updated, it is increasingly challenging for clinicians/providers to identify appropriate guidelines during the limited time of a patient visit. Providers lack the time to find all, or even the most relevant, guidelines during a patient visit, find the relevant sections within each guideline, and apply the guideline's recommendations. What constitutes the most relevant guidelines is a function not only of the patient's recent symptoms (as reported during the visit) but also the patient's health history, in which more recent entries may be more relevant than earlier entries.

In some embodiments, a query vector is automatically generated based at least in part on provider notes during the patient visit and notes from historical medical records of the patient. In some embodiments, a provider note vector (PNV) of a fixed size is automatically generated from visit notes manually entered through a keyboard or through voice recognition of words spoken in the exam room by the provider and the patient. The PNV is updated as the provider adds notes. In some embodiments, the PNV is generated using Bidirectional Encoder Representations from Transformers (BERT) trained exclusively on medical text (including provider visit notes). In some embodiments, the PNV is generated using techniques such as Word2Vec, Random Projection, and Term Frequency-Inverse Document Frequency (TF-IDF). An example of a visit note is “Patient experienced fasting glucose above range on at least five of the last ten days.” In some embodiments, a combined patient vector (CPV) of a fixed size is generated from Electronic Medical Records (EMR) based at least in part on each past visit by the patient. For each past visit by the patent, a visit vector of a fixed size comprising a vector representation of notes from the respective past visit is generated. The notes from each of the multiple past visits include a date and/or a timestamp that together with other notes is encoded into the visit vector, thus incorporating temporal aspects of the patient's record. In some embodiments, a visit vector is generated using BERT, Word2Vec, Random Projection, or TF-IDF.

In some embodiments, for a given past visit, the visit vector is a product of individual record category vectors (e.g., diagnoses record category, prescriptions record category, and treatment category). For each record (comprising a set of text associated with a timestamp), relevant diagnosis, treatment, and prescription codes are identified. Moreover, for each code, relevant descriptive texts are imported from the EMR notes. Having generated a visit vector for each past visit, the visit vectors are then combined to generate the CPV. In some embodiments, combining the visit vectors comprise providing each visit vector as input to a machine learning model (e.g., trained BERT model) that is configured to generate a vector of a fixed size as an output.

In some embodiments, the PNV and CPV are then combined to generate the query vector. Examples of techniques that could be utilized to combine the PNV and CPV include techniques that comprise aggregating the PNV and CPV, techniques that comprise computing the product of the PNV and the CPV, and/or techniques utilizing a machine learning model (e.g., BERT model). In some embodiments, a supervised learning algorithm is configured to determine the best method for combining the PNV and CPV.

In some embodiments, for each guideline/document, utilizing the same techniques (e.g., trained BERT model) as described above in relation to generating the query vector, a document vector (i.e., vector representation of the clinical guideline) is generated, and for each document section associated with the guideline/document, a section vector is generated. Because each guideline/document may be stored in a vector form, it is not required that document vectors and/or section vectors be generated in real-time.

In some embodiments, for each document vector, a similarity measure relative to the query vector is determined using techniques such as cosine similarity or neural ranking with weak supervision. The guidelines/documents are then ranked based at least in part on the respective similarity measures, and guidelines/documents with the top rank-ordered similarity measure are selected. In some embodiments, the guidelines with the top rank-ordered similarity measure are those that have a similarity measure above a defined threshold.

In some embodiments, for each section vector associated with a selected guideline, using techniques such as cosine similarity or neural ranking with weak supervision, a similarity measure relative to the query vector is determined. Sections with the greatest similarity measure are then selected using the same methods as described above in relation to selecting guidelines/documents.

In some embodiments, having selected the section vectors with the greatest similarity measures, the corresponding sections are displayed to the provider. The selected sections are ordered according to the similarity measure for the respective section. In some embodiments, ordering of search results is a learned ranking function. Metrics such as the sections selected by providers and amount of time spent on each selected section is used as indicators of the degree to which a section is relevant to a given provider's search. These metrics are used as labels in training data to adjust the vector representations (i.e., vectorization of text), weighing of the PNV relative to the CPV, and measurement of vector similarity to better order search results according to their relevance to providers.

### II. DEFINITIONS OF CERTAIN TERMS

The term “predictive entity” may refer to a data construct that is configured to describe an entity associated with a current real-world event in relation to which one or more predictive data analysis inferences may be generated using a multimodal hierarchical attention machine learning framework. An example of a predictive entity is a patient who seeks and/or receives medical services from a medical provider (also referred to in this disclosure as provider). In various embodiments, the predictive entity is associated with a current visit (e.g., medical visit) to a doctor's office, immediate care center, hospital, pharmacy, or the like to seek and/or receive one or more of a variety of services (e.g., treatment, diagnosis, prescription/medication, laboratory test, and/or the like), where the current visit describes the current real-world event. Additionally, in some embodiments, the predictive entity may be associated with one or more past real-world events. For example, a patient predictive entity may be associated with one or more past visits to a doctor's office, immediate care center, hospital, pharmacy, and/or the like. In some embodiments, each past real-world event may be associated with a historical input document that is configured to describe and/or comprise data associated with the corresponding past real-world event. For example, a patient predictive input entity may be associated with one or more Electronic Health Records (EHR) describing the patient's medical history as determined based at least in part on the past medical visits/encounters with respect to the patient. Additionally, a predictive entity may be associated with a current input document that is configured to describe and/or comprise data associated with the current real-world event. For example, a patient predictive entity may be associated with a current medical visit document data object (e.g. current EHR) that includes provider notes generated with respect to the predictive entity.

The term “current input document” may refer to a data construct that comprises, represents, and/or records data and/or information associated with a current real-world event that is associated with a predictive entity. For example the current input document may describe an electronically maintained data object that is configured to describe and/or comprise natural language content data (e.g., text data) associated with the current real-world event that is associated with a predictive entity, such as visit/encounter document data object generated with respect to a current visit/encounter involving the predictive entity. For example, in some embodiments, a current input document may describe a current visit document data object (e.g. current Electronic Health Record (EHR)) that is being generated by and/or for a provider in real-time with respect to a current patient visit to a doctor's office, immediate care center, clinic, hospital, pharmacy, and/or the like. For example, a current input document may be generated and/or periodically updated during the associated current real-world event.

The term “historical input document” may refer to a data construct that comprises, represents, and/or records data and/or information associated with a past real-world event associated with a predictive entity. An example of a historical input document is a medical visit document data object (e.g., Electronic Health Record (EHR)) associated with a patient who visited a doctor's office, immediate care center, clinic, hospital, pharmacy, and/or the like for one or more of a variety of reasons (e.g., to seek medical treatment, to seek medical diagnosis, to seek laboratory test, to seek pharmacy prescriptions, and/or the like). In some embodiments, each medical visit data object, may comprise, represent, and/or record data and/or information associated with a particular medical visit by the patient, such that the plurality of medical visit data objects (e.g., historical input documents) may comprise, represent, and/or describe the patient's medical history. For example, in the noted clinical guideline search context, the EHR historical input documents may include provider notes and/or information collected by and/or for the doctor, clinician, pharmacist, and/or the like, as well as other health-related data associated with the patient.

The term “reference document” may refer to a data construct that comprises, represents, and/or records data and/or information associated with one or more subject matters and/or disciplines. An example of a reference document is a clinical guideline comprising content data, such as systematically developed statements configured to assist providers and/or patients with respect to appropriate action for specific clinical circumstance(s). In some embodiments, a reference document may comprise one or more reference document sections that comprise a subset of the content data associated with the reference document. In some embodiments, a plurality of reference documents may be pre-processed to generate a plurality of per-document referential embeddings, and for each reference document section of a reference document, a per-section referential embedding. In some embodiments, the per-document referential embeddings and per-section referential embeddings are stored in one or more repositories.

The term “multimodal hierarchical attention machine learning framework” may refer to a data construct that describes parameters, hyperparameters, and/or defined operations of a machine learning model that is configured to process data associated with an input document data object and/or data associated with a plurality of input document data objects using one or more attention mechanisms (e.g., self-attention mechanism, bidirectional self-attention mechanism, and/or the like) to generate an embedded representation (e.g., fixed-size vector representation) of the input document data object and/or an embedded representation of a plurality of input document data objects. Examples of input document data objects include historical input documents, current input documents, reference documents, and/or the like.

In some embodiments, the multimodal hierarchical attention machine learning framework comprises: (i) a plurality of per-modality cross-token attention machine learning models each describing a multimodal transformer history encoder, each associated with a historical input modality of a plurality of historical input modalities, and each configured to generate a modality representation for a subset of P input tokens of a historical input document having a historical input modality of the corresponding per-modality cross-token attention machine learning model using one or more attention mechanisms (e.g., self-attention mechanism, bidirectional self-attention mechanism, and/or the like); (ii) a cross-modality attention machine learning model describing a multimodal transformer history encoder that is configured to process each modality representation output of the plurality of per-modality cross-token attention machine learning models to generate a per-document historical input embedding for the P input tokens of the historical input document using one or more attention mechanisms (e.g., self-attention mechanism, bidirectional self-attention mechanism, and/or the like); (iii) a cross-temporal attention machine learning model describing a multimodal transformer history encoder that is configured to process each per-document historical input embedding along with the associated temporal information to generate a historical input embedding for the predictive entity using one or more attention mechanisms (e.g., self-attention mechanism, bidirectional self-attention mechanism, and/or the like); (iv) a per-document cross-token attention machine learning model describing a multimodal transformer hierarchical text encoder that is configured to process text data extracted from a current input document to generate a current input embedding for the current input document using one or more attention mechanisms (e.g., self-attention mechanism, bidirectional self-attention mechanism, and/or the like); (v) a cross-section attention machine learning model describing a multimodal transformer hierarchical text encoder that is configured to process each reference document section of a reference document to generate a per-section referential embedding for each respective reference document section of the reference document using one or more attention mechanisms (e.g., self-attention mechanism, bidirectional self-attention mechanism, and/or the like); (vi) a per-document cross-section attention machine learning model describing a multimodal transformer hierarchical text encoder that is configured to process a reference document to generate a per-document referential embedding of the reference document using one or more attention mechanisms (e.g., self-attention mechanism, bidirectional self-attention mechanism, and/or the like). In various embodiments, an input token may describe a word (e.g., one or more characters and/or numbers). For example, an input token associated with an historical input document may describe a word associated with the historical input document.

The term “per-modality cross-token attention machine learning model” may refer to a data construct that describes parameters, hyperparameters, and/or defined operations of a machine learning model that is configured to generate, in accordance with one or more attention mechanisms (e.g., self-attention mechanism, bidirectional self-attention mechanism, and/or the like) and based at least in part on a plurality of input tokens of a historical input document associated with a historical input modality of the per-modality cross-token attention machine learning model, a context-based modality representation for the historical input modality. In some embodiments, the context-based modality representation for a historical input modality is generated based at least in part on a set of attention weights associated with the per-modality cross-token attention machine learning model, where in some embodiments, each attention weight is associated with a pair of input tokens that are both associated with a common attention window, and describes a predicted semantic relationship significance of the pair of input tokens. In some embodiments, inputs to a per-modality cross-token attention machine learning model comprise one or more vectors describing an input token, such as a vector describing a categorical input feature (e.g., a diagnosis code, a procedure code, medication, and/or the like) associated with the historical input document. In some embodiments, outputs of the per-modality cross-token attention machine learning model comprise a fixed-size vector describing a modality representation of the input tokens associated with the corresponding historical input modality. In some embodiments, like other components of the multimodal hierarchical attention machine learning framework, the per-modality cross-token attention machine learning model is trained based at least in part on text data (e.g., medical domain text data). In some embodiments, the per-modality cross-token attention machine learning model is trained based at least in part on historical categorical input features along with associated text data.

The term “cross-modality attention machine learning model” may refer to a data construct that describes parameters, hyperparameters, and/or defined operations of a machine learning model that is configured to process each modality representation output of the plurality of per-modality cross-token attention machine learning models in accordance with one or more attention mechanisms (e.g., self-attention mechanism, bidirectional self-attention mechanism, and/or the like) to generate a per-document historical input embedding for the associated historical input document. In some embodiments, inputs to a cross-modality attention machine learning model comprise one or more vectors each describing a modality representation for a historical input modality associated with a particular historical input document. In some embodiments, outputs of the per-modality cross-token attention machine learning model comprise a fixed-size vector describing a per-document historical input embedding for a historical input document. In some embodiments, like other components of the multimodal hierarchical attention machine learning framework, the cross-modality attention machine learning model is trained based at least in part on text data (e.g., medical domain text data).

The term “cross-temporal attention machine learning model” may refer to a data construct that describes parameters, hyperparameters, and/or defined operations of a machine learning model that is configured to process each per-document historical input embedding along with the associated temporal information in accordance with one or more attention mechanisms (e.g., self-attention mechanism, bidirectional self-attention mechanism, and/or the like) to generate a historical input embedding for the predictive entity. In some embodiments, inputs to a cross-temporal attention machine learning model comprise one or more vectors each describing a per-document historical input embedding along with corresponding temporal information. In some embodiments, outputs of the per-modality cross-token attention machine learning model comprise a fixed-size vector describing a historical input embedding for the predictive entity. In some embodiments, like other components of the multimodal hierarchical attention machine learning framework, the cross-temporal attention machine learning model is trained based at least in part on text data (e.g., medical domain text data).

The term “per-document cross-token attention machine learning model” may refer to a data construct that describes parameters, hyperparameters, and/or defined operations of a machine learning model that is configured to process text data (e.g., provider notes) extracted from a current input document in accordance with one or more attention mechanisms (e.g., self-attention mechanism, bidirectional self-attention mechanism, and/or the like) to generate a context-based current input embedding for the current input document. In some embodiments, a context-based current input embedding for a current input document is generated based at least in part on a set of attention weights associated with the per-document cross-token attention machine learning model, where in some embodiments, each attention weight is associated with a pair of input tokens that are both associated with a common attention window, and describes a predicted semantic relationship significance of the pair of input tokens. In some embodiments, inputs to a per-document cross-token attention machine learning model comprise one or more vectors describing input tokens (e.g., words) associated with the current input document. In some embodiments, outputs of the per-document cross-token attention machine learning model comprise a fixed-size vector describing a current input embedding for a current input document. In some embodiments, like other components of the multimodal hierarchical attention machine learning framework, the a per-document cross-token attention machine learning model is trained based at least in part on text data (e.g., medical domain text data).

The term “cross-section attention machine learning model” may refer to a data construct that describes parameters, hyperparameters, and/or defined operations of a machine learning model that is configured to process each reference document section of a reference document in accordance with one or more attention mechanisms (e.g., self-attention mechanism, bidirectional self-attention mechanism, and/or the like) to generate a context-based per-section referential embedding for each respective reference document section of the reference document using one or more attention mechanisms (e.g., self-attention mechanism, bidirectional self-attention mechanism, and/or the like). In some embodiments, context-based per-section referential embedding for a reference document section is generated based at least in part on a set of attention weights associated with the cross-section attention machine learning model, where in some embodiments, each attention weight is associated with a pair of input tokens that are both associated with a common attention window, and describes a predicted semantic relationship significance of the pair of input tokens. In some embodiments, inputs to a cross-section attention machine learning model comprise one or more vectors describing input tokens (e.g., word tokens) associated with the reference document section. In some embodiments, outputs of the cross-section attention machine learning model comprise a fixed-size vector describing a per-section referential embedding for a reference document section. In some embodiments, like other components of the multimodal hierarchical attention machine learning framework, the cross-section attention machine learning model is trained based at least in part on text data (e.g., medical domain text data).

The term “per-document cross-section attention machine learning model” may refer to a data construct that describes parameters, hyperparameters, and/or defined operations of a machine learning model that is configured to process a reference document in accordance with one or more attention mechanisms (e.g., self-attention mechanism, bidirectional self-attention mechanism, and/or the like) to generate a per-document referential embedding of the reference document. In some embodiments, the per-document referential embedding for a reference documents is generated based at least in part on each per-section referential embedding for each reference document section of the reference document. In some embodiments, inputs to a per-document cross-section attention machine learning model comprise one or more vectors describing input tokens (e.g., word tokens or per-section referential embeddings) associated with the reference document. In some embodiments, outputs of the per-document cross-section attention machine learning model comprise a fixed-size vector describing a per-document referential embedding for a reference document. In some embodiments, like other components of the multimodal hierarchical attention machine learning framework, the per-document cross-section attention machine learning model is trained based at least in part on text data (e.g., medical domain text data).

The term “per-document embedding similarity measure” may refer to a data construct that describes a computed/predicted similarity measure between two embeddings, such as a computed/predicted similarity measure between a cross-temporal input embedding associated with a predictive entity and a per-document referential embedding of a reference document. For example, in some embodiments, given a cross-temporal input embedding and a per-document referential embedding, the per-document embedding similarity measure for the embedding pair may be generated based at least in part on a distance/similarity measure (e.g., a cosine distance measure, a cosine distance similarity measure, and/or the like) of the cross-temporal input embedding and the per-document referential embedding.

The term “per-section embedding similarity measure” may refer to a data construct that describes a computed/predicted similarity measure between two embeddings, such as a computed/predicted similarity measure between a cross-temporal input embedding associated with a predictive entity and a per-section referential embedding associated with the predictive entity. For example, in some embodiments, given a cross-temporal input embedding and a per-section referential embedding, the per-section embedding similarity measure for the embedding pair may be generated based at least in part on a distance/similarity measure (e.g., a cosine distance measure, a cosine distance similarity measure, and/or the like) of the cross-temporal input embedding and the per-section referential embedding.

### III. COMPUTER PROGRAM PRODUCTS, METHODS, AND COMPUTING ENTITIES

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DINIM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like, executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### IV. EXEMPLARY SYSTEM ARCHITECTURE

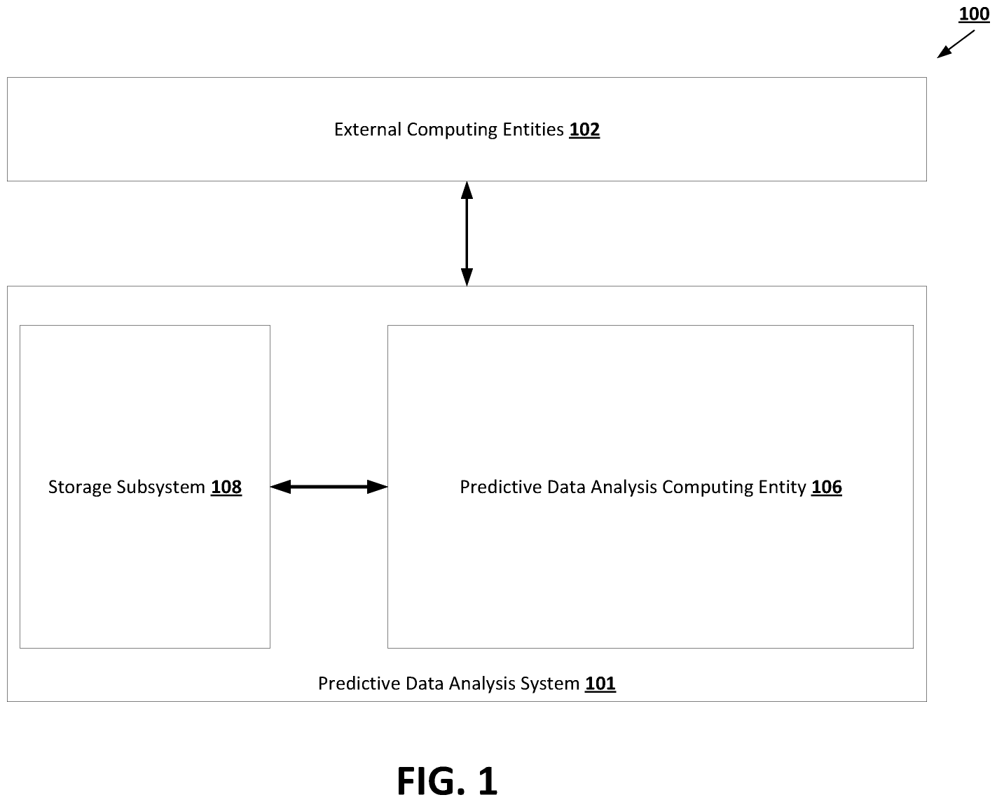

FIG. 1 is a schematic diagram of an example architecture 100 for performing cross-temporal search result prediction. The architecture 100 includes a predictive data analysis system 101 configured to receive cross-temporal search prediction requests from external computing entities 102, process the cross-temporal search prediction requests to generate predictions, provide the generated predictions to the external computing entities 102, and automatically perform prediction-based actions based at least in part on the generated predictions.

An example of a prediction-based action that can be performed using the predictive data analysis system 101 is a request to generate a cross temporal search result prediction that describes and/or comprise the most relevant guideline sections with respect to a particular clinical circumstance. Unwarranted variation in health care (i.e., medical practice patterns that cannot be explained by illness, medical need, or the recommendation of evidence-based medicine) is known to be a major driver of low value care. One tool for combating unwarranted variation is the use of clinical guidelines which are systematically developed statements to assist practitioner and patient decisions about appropriate action for specific clinical circumstance. Clinical guidelines contain recommendations that are based at least in part on evidence from rigorous and comprehensive review of published medical literature. However, as guidelines proliferate and are updated, it is increasingly challenging for clinicians to identify appropriate guideless during the limited time of a patient visit. The amount of time that providers are budgeted to spend on a given visit or a patient is brief and have been getting shorter. Providers lack the time to find all, or even the most relevant, guidelines during a visit, find the relevant sections within each guideline, and apply the guideline's recommendations to the prescribed treatment. Generally, what constitutes the most relevant guidelines is a function not only of the patient's recent symptoms reported during the visit, but also the patient's health history, in which more recent entries may be more relevant that earlier entries. Various embodiments of the present invention automatically (i) generate a contextualized query vector in real-time for a medical provider with respect to a patient and/or visit based at least in part on a context-based vector representation of a provider's note being generated (e.g., as the provider types) and a context-based vector representation of the medical history of the patient, and (ii) generate a contextualized search result based at least in part on identifying vector representations of clinical guidelines sections having the highest similarity measures relative to the query vector (i.e., most relevant clinical guideline sections).

In some embodiments, predictive data analysis system 101 may communicate with at least one of the external computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive cross-temporal search prediction requests from one or more external computing entities 102, process the cross-temporal search prediction requests to generate predictions corresponding to the cross-temporal search prediction requests, provide the generated predictions to the external computing entities 102, and automatically perform prediction-based actions based at least in part on the generated predictions.

The storage subsystem 108 may be configured to store input data used by the predictive data analysis computing entity 106 to perform cross-temporal search prediction, as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Predictive Data Analysis Computing Entity

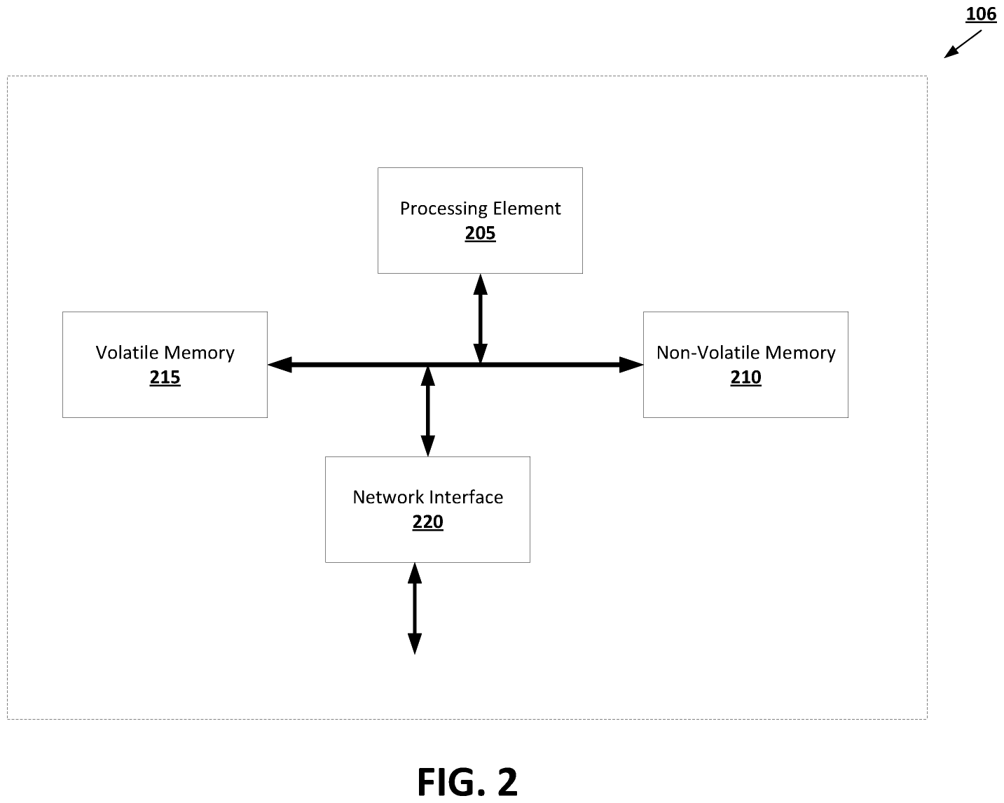

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include, or be in communication with, non-volatile media (also referred to as non-volatile storage, memory, memory storage, memory circuitry, and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 106 may further include, or be in communication with, volatile media (also referred to as volatile storage, memory, memory storage, memory circuitry, and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

### Exemplary External Computing Entity

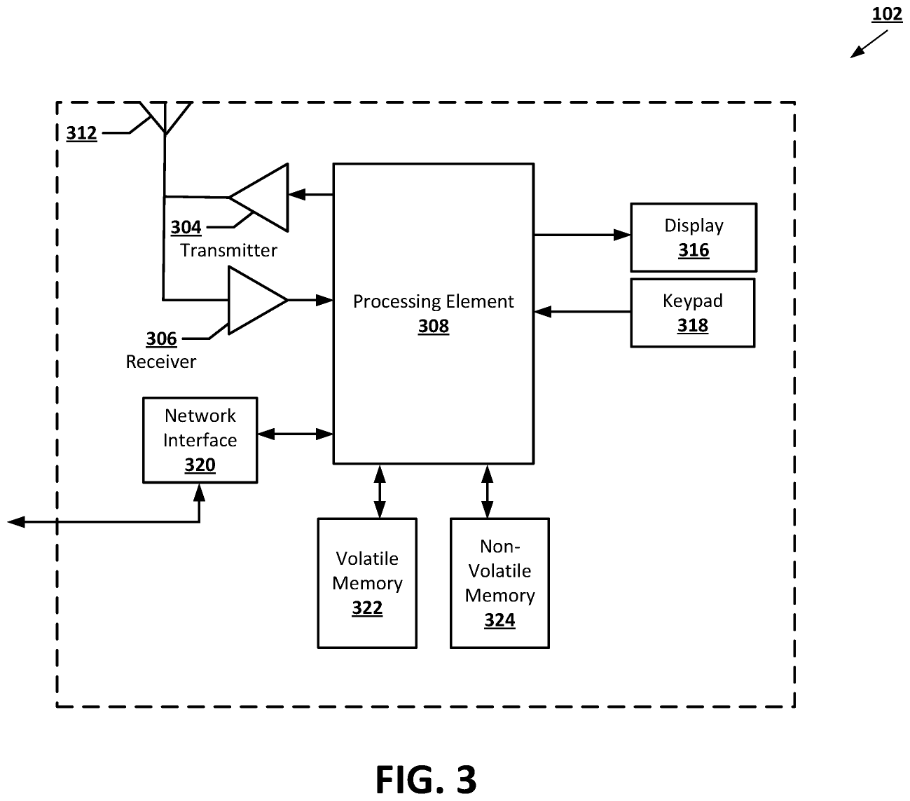

FIG. 3 provides an illustrative schematic representative of an external computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. External computing entities 102 can be operated by various parties. As shown in FIG. 3, the external computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the external computing entity 102 may be capable of operating with one or more air interface standards, communication protocols, modulation types, and access types. More particularly, the external computing entity 102 may operate in accordance with any of a number of wireless communication standards and protocols, such as those described above with regard to the predictive data analysis computing entity 106. In a particular embodiment, the external computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102 may operate in accordance with multiple wired communication standards and protocols, such as those described above with regard to the predictive data analysis computing entity 106 via a network interface 320.

Via these communication standards and protocols, the external computing entity 102 can communicate with various other entities using concepts, such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102 can also download changes, add-ons, and updates, for instance, to its firmware, software (e.g., including executable instructions, applications, program modules), and operating system.

According to one embodiment, the external computing entity 102 may include location determining aspects, devices, modules, functionalities, and/or similar words used herein interchangeably. For example, the external computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the external computing entity's 102 position in connection with a variety of other systems, including cellular towers, Wi-Fi access points, and/or the like. Similarly, the external computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies, including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The external computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the external computing entity 102 to interact with and/or cause display of information/data from the predictive data analysis computing entity 106, as described herein. The user input interface can comprise any of a number of devices or interfaces allowing the external computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the external computing entity 102, and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The external computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the external computing entity 102. As indicated, this may include a user application that is resident on the entity or accessible through a browser or other user interface for communicating with the predictive data analysis computing entity 106 and/or various other computing entities.

In another embodiment, the external computing entity 102 may include one or more components or functionalities that are the same or similar to those of the predictive data analysis computing entity 106, as described in greater detail above. As will be recognized, these architectures and descriptions are provided for exemplary purposes only and are not limiting to the various embodiments.

In various embodiments, the external computing entity 102 may be embodied as an artificial intelligence (AI) computing entity, such as an Amazon Echo, Amazon Echo Dot, Amazon Show, Google Home, and/or the like. Accordingly, the external computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. EXEMPLARY SYSTEM OPERATIONS

As described below, various embodiments of the present disclosure make important technical contributions to improving predictive accuracy of search result generation machine learning models that operate on multi-modality input data by using cross-modality attention machine learning models as part of the encoding mechanism of the noted search result generation machine learning models, an improvement which in turn enhances training speed and training efficiency of machine learning models. It is well-understood in the relevant art that there is typically a tradeoff between predictive accuracy and training speed, such that it is trivial to improve training speed by reducing predictive accuracy, and thus the real challenge is to improve training speed without sacrificing predictive accuracy through innovative model architectures, see, e.g., Sun et al., Feature-Frequency—Adaptive On-line Training for Fast and Accurate Natural Language Processing in 40(3) Computational Linguistic 563 at Abst. (“Typically, we need to make a tradeoff between speed and accuracy. It is trivial to improve the training speed via sacrificing accuracy or to improve the accuracy via sacrificing speed. Nevertheless, it is nontrivial to improve the training speed and the accuracy at the same time”). Accordingly, the techniques described herein improve predictive accuracy without harming training speed, such as various techniques described herein, enable improving training speed given a constant predictive accuracy. In doing so, the techniques described herein improve accuracy, efficiency, and speed of search result generation machine learning models, thus reducing the number of computational operations needed and/or the amount of training data entries needed to train search result generation machine learning models. Accordingly, the techniques described herein improve at least one of the computational efficiency, storage-wise efficiency, and speed of training search result generation machine learning models.

Moreover, various embodiments of the present disclosure enable practical applications related to performing operational load balancing for post-prediction systems by using cross-temporal search result classifications generated based at least in part on cross-temporal search result predictions to determine an optimal number of computing entities needed to perform the noted post-processing operations. For example, in some embodiments, a predictive data analysis computing entity determines L cross-temporal search result classifications for L predictive entities based at least in part on the cross-temporal search result predictions for the predictive entities. Then, the count of predictive entities that are associated with affirmative cross-temporal search result classifications, along with a resource utilization ratio for each predictive entity, can be used to predict a predicted number of computing entities needed to perform post-prediction processing operations (e.g., automated investigation operations) with respect to the L predictive entities. For example, in some embodiments, the number of computing entities needed to perform post-prediction processing operations (e.g., automated investigation operations) with respect to the L predictive entities can be determined based at least in part on the output of the equation: R=ceil(Σₖ^{k=K}urₖ), where R is the predicted number of computing entities needed to perform post-prediction processing operations with respect to the L predictive entities, cell(⋅) is a ceiling function that returns the closest integer that is greater than or equal to the value provided as the input parameter of the ceiling function, k is an index variable that iterates over K predictive entities among the L predictive entities that are associated with affirmative cross-temporal search result classifications, and urₖ is the estimated resource utilization ratio for a kth predictive entity that may be determined based at least in part on an input batch size associated with the kth predictive entity. In some embodiments, once R is generated, the predictive data analysis computing entity can use R to perform operational load balancing for a server system that is configured to perform post-prediction processing operations (e.g., automated investigation operations) with respect to the L predictive entities. This may be done by allocating computing entities to the post-prediction processing operations if the number of currently-allocated computing entities is below R, and deallocating currently-allocated computing entities if the number of currently-allocated computing entities is above R.

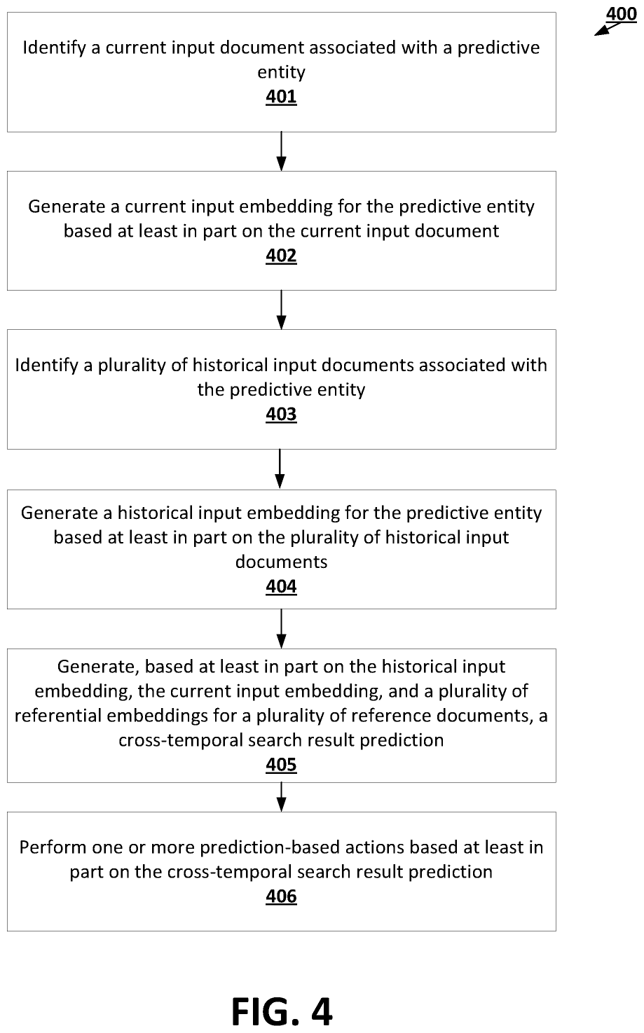

FIG. 4 provides a flowchart diagram of an example process 400 for generating cross-temporal search result prediction with respect to a predictive entity. Via the various steps/operations of the process 400, the predictive data analysis computing entity 106 can efficiently and reliably generate a cross-temporal search result prediction for a predictive entity, and perform one or more prediction-based actions based at least in part on the cross temporal search result prediction. In various embodiments the predictive data analysis computing entity 106 is configured to receive and/or extract text data from a current input document and generate a cross-temporal search result prediction for the predictive entity based at least in part on the text data and discrete data elements (e.g., categorical input features) from a set of historical input documents.

### Generating Current Input Embedding

In various embodiments, the process 400 begins at step/operation 401 when the predictive data analysis computing entity 106 identifies a current input document associated with a predictive entity, where a predictive entity may describe an entity (e.g., an individual, group of individuals, and/or the like) with respect to which one or more predictive data analysis inferences may be generated. An example of a current input document is an electronically maintained document data object that is configured to describe and/or comprise natural language content data (e.g., text data) associated with a current real-world event that is associated with a predictive entity. For example, a current input document may be a visit/encounter document data object generated with respect to a current visit/encounter (e.g., current real-world event) involving the predictive entity. For example, in a clinical guideline search context, a current input document may describe a visit document data object (e.g., medical visit document data object) comprising provider notes text data (e.g., sequence of words) generated by and/or for a provider with respect to a current medical visit by a patient predictive entity, such as a medical visit to a doctor's office, immediate care center, clinic, hospital, pharmacy, and/or the like, where the medical visit may be for one or more of a variety of reasons (e.g., to seek medical treatment, to seek medical diagnosis, to seek laboratory test, to seek pharmacy prescriptions, and/or the like).

In various embodiments, a current input document may be generated in real-time or near-real time. For example, a medical visit document data object may be generated during a patient's visit to a doctor's office, immediate care center, clinic, hospital, pharmacy, and/or the like while the patient is being attended to (e.g., being observed by a medical provider). In the noted clinical guideline search context example, a medical visit document data object may comprise or otherwise describe a current Electronic Health Record (EHR) that includes provider notes being generated by and/or for the provider with respect to a patient medical visit, where the provider notes may include natural language text data describing the provider's observation, symptoms, medications, treatment, and/or the like with respect to the patient predictive entity. Additionally, in some embodiments, the medical visit document data object may include one or more discrete data items, such as medical codes (e.g., diagnosis codes, such as International Statistical Classification of Diseases (ICD) codes), procedure codes, such as Current Procedural Terminology (CPT) codes), and/or the like). A current input document may be generated in a variety of ways. For example, a current input document may be generated manually utilizing a keyboard. As another example, a current input document may be generated via voice recognition of spoken words (e.g. words spoken during an interaction between two or more parties, such as interaction between a provider and a patient).

At step/operation 402, the predictive data analysis computing entity 106 generates a current input embedding for the predictive entity based at least in part on the text data associated with the current input document, where a current input embedding may describe a fixed-size vector representation of the provider notes text data associated with the current input document. In some embodiments, generating a current input embedding for a current input document comprises identifying and/or extracting text data (e.g., collection of words corresponding to provider notes) from the current input document and processing the text data utilizing one or more of a variety of techniques (e.g., Word2Vec, Random Projection, Term Frequency—Inverse Document Frequency (TF-IDF), transformers, and/or the like) to generate the current input embedding. In various embodiments, the predictive data analysis computing entity 106 generates the current input embedding for the current input document utilizing a per-document cross-token attention machine learning model of a multimodal hierarchical attention machine learning framework that is configured to process text data extracted from an input document data object using one or more attention mechanisms (e.g., self-attention mechanism, bidirectional self-attention mechanism, and/or the like) to generate a contextualized embedded representation (e.g., fixed-size vector representation) of the extracted text data. For example, in some embodiments, the per-document cross-token attention machine learning model may describe a multimodal transformer hierarchical text encoder that is configured to process text data extracted from a current input document using one or more attention mechanisms (e.g., self-attention mechanism, bidirectional self-attention mechanism, and/or the like) to generate a context-based embedded representation (e.g., fixed-size vector representation) of the extracted text data based at least in part on each word token in the text data.

In some embodiments, the multimodal hierarchical attention machine learning framework may be a pretrained Bidirectional Encoder Representations from Transformers (BERT) that is trained based at least in part on text data. In the noted clinical guideline search context, for example, the multimodal hierarchical attention machine learning framework may be trained based at least in part on medical domain text data, where the medical domain text data may include provider notes text data. For example, in some embodiments, the multimodal hierarchical attention machine learning framework is trained based at least in part on historical EHR data including historical provider notes text data.

In various embodiments, to generate a current input embedding for a current input document, the predictive data analysis computing entity 106 provides as input to the per-document cross-token attention machine learning model, text data extracted from the current input document. In various embodiments, in response to receiving the text data, the per-document cross-token attention machine learning model processes the text data based at least in part on each input token associated with the text data to generate in accordance with an attention mechanism a current input embedding that describes a context-based fixed-size vector representation of the text data. For example, in the noted clinical guideline search context, the predictive data analysis computing entity 106 may be configured to extract provider notes text data (e.g., sequence of words, sentence, and/or the like) from the current input document and provide the extracted provider notes text data to the per-document cross-token attention machine learning model. In the noted example, in response to receiving the provider notes text data, the per-document cross-token attention machine learning model processes the provider notes text data to generate in accordance with an attention mechanism a current input embedding that describes a notes-wise fixed-size vector representation of the provider notes text data based at least in part on each word token of the sequence of word tokens of the provider notes text data.

For example, consider where a current input document that is a medical visit document data object being generated by a provider in connection with a patient visit includes the following provider notes text data: “patient experienced fasting glucose above range on at least five of the last ten days.” In the noted example, the per-document cross-token attention machine learning model may receive the provider notes text data “patient experienced fasting glucose above range on at least five of the last ten days” from the predictive data analysis computing entity 106, and process the provider notes text data in accordance with an attention mechanism and based at least in part on each word token (e.g., patient, experienced, fasting, and the like) of the provider notes text data to generate a current input embedding of the provider notes text data, where the current input embedding describes a context-based fixed-size vector representation of “patient experienced fasting glucose above range on at least five of the last ten days.” In some embodiments, the attention mechanism of a per-document cross-token attention machine learning model generates a context-based vector representation of a current input document based at least in part on a set of attention weights associated with the per-document cross-token attention machine learning model. In some embodiments, each attention weight is associated with a pair of input tokens (e.g., word tokens) that are both associated with a common attention window and describes a predicted semantic relationship significance of the pair of input tokens.

In some embodiments, the per-document cross-token attention machine learning model is configured to periodically update the current input embedding based at least in part on updated current input document (e.g., updated text data associated with the current input document). As noted above, in various embodiments, a current input document may be generated in real-time and/or near real-time during the corresponding real-world event. Moreover, in various embodiments, the current input document may be updated during the real-world event. For example, continuing with the clinical guideline search context example, a current input document that is a medical visit document data object comprising provider notes may be generated by and/or for the corresponding provider during a medical visit, and may be updated by and/or for the provider during the visit (e.g., by adding to the existing provider notes, modifying the existing provider notes, and/or the like). In some embodiments, in response (e.g., periodically) to an updated current input document, the predictive data analysis computing entity 106 extracts and provides the updated text data associated with the current input document to the per-document cross-token attention machine learning model. In some embodiments, in response to receiving the updated text data, the per-document cross-token attention machine learning model processes the updated text data to generate updated current input embedding for the current input document, which is subsequently used to generate the cross-temporal search result prediction.

At step/operation 403, the predictive data analysis computing entity 106 identifies historical input documents associated with the predictive entity. In some embodiments, the predictive data analysis computing entity 106 may identify a plurality of historical input documents associated with the predictive entity. A historical input document may describe a document data object that comprises, represents, and/or records data and/or information associated with a past real-world event associated with a predictive entity. For example, in some embodiments, each historical input document may describe a historical medical visit document data object (e.g., Electronic Health Record (EHR)) associated with a patient who visited a doctor's office, immediate care center, clinic, hospital, pharmacy, and/or the like for one or more of a variety of reasons (e.g., to seek medical treatment, to seek medical diagnosis, to seek laboratory test, to seek pharmacy prescriptions, and/or the like). In the noted clinical guideline search context example, each medical visit document data object may comprise, represent, and/or record data and/or information associated with a particular medical visit by the patient, such that the plurality of medical visit document data objects (e.g., historical input documents) describes the patient's medical history.

As noted above, each historical input document may be associated with a past real-world event. In some embodiments, each past real-world event may be associated with temporal information (e.g., date and/or time). Accordingly, in some embodiments, each historical input document may be associated with temporal information. For example, in the noted clinical guideline search context, each historical medical visit document data object may be associated with a date and/or time when the corresponding patient visited a doctor's office, immediate care center, clinic, hospital, pharmacy, and/or the like, and may form a portion of the data associated with the historical medical visit document data object. For example, a first historical input document for a predictive entity may be associated with May 2, 1998 temporal information, where May 2, 1998 describes the date of occurrence of the past real-world event associated with the first historical input document (e.g., the date a patient predictive entity visited a doctor's office), As another example, a second historical input document for the predictive entity may be associated with Jun. 2, 2020 temporal information, where Jun. 2, 2020 describes the date of occurrence of the past real-world event associated with the second historical input document (e.g., the date the patient predictive entity visited an emergency room). As noted above, in some embodiments, one or more historical input documents may include data that describes the temporal information. For example, in some embodiments, each historical input document may include data that describes the temporal information. For example, continuing with the clinical guideline search context example, each historical input document may include a date and/or time of the corresponding medical visit.

In some embodiments, each historical input document may comprise one or more categorical input features associated with the predictive entity, where a categorical input feature may describe discrete categorical data (e.g., structured data) associated with a visit/encounter corresponding to or otherwise associated with the historical input document. For example, in some embodiments one or more categorical input features associated with a particular historical input document may be generated as a result of a visit/encounter with respect to which the particular historical input document was generated, or otherwise generated in connection with visit/encounter. In the noted clinical guideline search context, examples of categorical input features that may be present in a historical input document include: (i) diagnosis code categorical input features (e.g., International Classification of Diseases (ICD) codes), (ii) procedural code categorical input features (e.g., Current Procedural Terminology (CPT) codes), (iii) pharmacy code categorical input features, (iv) medication categorical input features, (v) vitals categorical input features, (vi) laboratory test categorical input features, (vii) laboratory test result categorical input features (e.g., Logical Observation Identifiers Names and Codes (LOINCS)), (viii) treatment code categorical input features, (ix) treatment categorical input features, and/or the like. In some embodiments, a current input document may also include unstructured text data.

In some embodiments, each categorical input feature may be associated with a historical input modality of a plurality of historical input modalities. A historical input modality may describe a modality taxonomy comprising a plurality of classifications/categories, where each categorical input feature may be associated with a particular classification/category of the plurality of classifications/categories in the modality taxonomy. In some embodiments, the plurality of historical input modalities are defined by a modality taxonomy that is shared across the plurality of historical input documents. For example, in the noted clinical guideline search context, the plurality of historical input modalities may include: (i) diagnosis historical input modality, (ii) prescription historical input modality (also referred to herein as medication modality), (iii) vitals historical input modality, (iv) laboratory test historical input modality, (v) laboratory test result historical input modality, (vi) procedure historical input modality, (vii) treatment historical input modality, and/or the like. For example, diagnosis code categorical input features (e.g., ICD codes) may be associated with diagnosis historical input modality. As another example, procedure code categorical input features (e.g., CPT codes) may be associated with procedure historical input modality. As yet another example, laboratory test result codes (e.g., LOINCS) may be associated with laboratory test result historical input modality.

In some embodiments, each categorical input feature in a historical input document may be associated with a per-modality segment of a plurality of per-modality segments in the historical input document, where each per-modality segment may describe a segment (e.g., section) in the corresponding historical input document that is associated with a particular historical input modality of the plurality of historical input modalities and/or may be configured for storing categorical input features having a historical input modality of the per-modality segment. For example, a particular per-modality segment may be associated with diagnosis historical input modality. As another example, a particular per-modality segment may be associated with procedure historical input modality. In some embodiments, each categorical input feature in a historical input document may be automatically and/or manually associated with and/or assigned a historical input modality.

In some embodiments, one or more categorical input features of a historical input document may be associated with one or more text descriptors of a plurality of text descriptors, where the multimodal hierarchical attention machine learning framework may be trained based at least in part on the plurality of text descriptors. A text descriptor may describe or otherwise comprise textual description (e.g., text data) associated with a categorical input feature and may be configured to describe the categorical input feature. For example, in the noted clinical guideline search context example, a particular diagnosis code (e.g., ICD code) categorical input feature present in a historical input document may be associated with text data corresponding to and/or describing the particular diagnosis code categorical input feature. As another example, a particular procedure code (e.g., CPT code) categorical input feature present in a historical input document may be associated with text data corresponding to and/or describing the particular procedure code categorical input feature. As yet another example, a particular laboratory test result code (e.g., LOINCS code) categorical input feature present in a historical input document may be associated with text data corresponding to and/or describing the laboratory test result categorical input feature. As a further example, a particular pharmacy/medication code categorical input feature and/or pharmacy/medication descriptor categorical input feature present in the historical input document may be associated with text data corresponding to and/or describing the pharmacy/medication code categorical input feature and/or pharmacy/medication descriptor categorical input feature. Accordingly, in some embodiments, one or more text descriptors may be associated with a given historical input document based at least in part on the categorical input features present in the given historical input document.

In some embodiments, the predictive data analysis computing entity 106 may retrieve or receive the plurality of historical input documents associated with the predictive entity from one or more historical input document repositories (e.g., EHR repository) and/or computing entities storing the one or more historical input documents. For example, in some embodiments, the predictive data analysis computing entity 106 may be configured to retrieve a historical input document from a historical input document repository. As another example, in some embodiments, the predictive data analysis computing entity 106 may be configured to receive a historical input document from an external computing entity and/or historical input document repository.

At step/operation 404, the predictive data analysis computing entity 106 generates a historical input embedding for the predictive entity based at least in part on the plurality of historical input documents associated with the predictive entity, where a historical input embedding may describe a fixed-size vector representation of all of the identified categorical input features of the plurality of historical input documents associated with the predictive entity.

In various embodiments, to generate the historical input embedding, the predictive data analysis computing entity 106 identifies and extracts categorical input features associated with the historical input documents associated with the predictive entity, and generates the historical input embedding for the predictive entity based at least in part on each extracted categorical input feature. In some embodiments, generating a historical input embedding for the predictive entity comprises generating a plurality of per-document historical input embeddings for the plurality of historical input documents, where a particular per-document historical input embedding may describe a fixed-size vector representation of a particular historical input document of the plurality of historical input documents, and may be generated based at least in part on each identified categorial input feature associated with the particular historical input document. In various embodiments, each per-document historical input embedding of the plurality of per-document historical input embeddings have a uniform vector size (e.g., the same vector size). In various embodiments, subsequent to generating the plurality of per-document historical input embeddings, the predictive data analysis computing entity 106, based at least in part on each per-document historical input embedding and utilizing one or models of the multimodal hierarchical attention machine learning framework, generates the historical input embedding.

### Generating Per-Document Historical Input Embedding

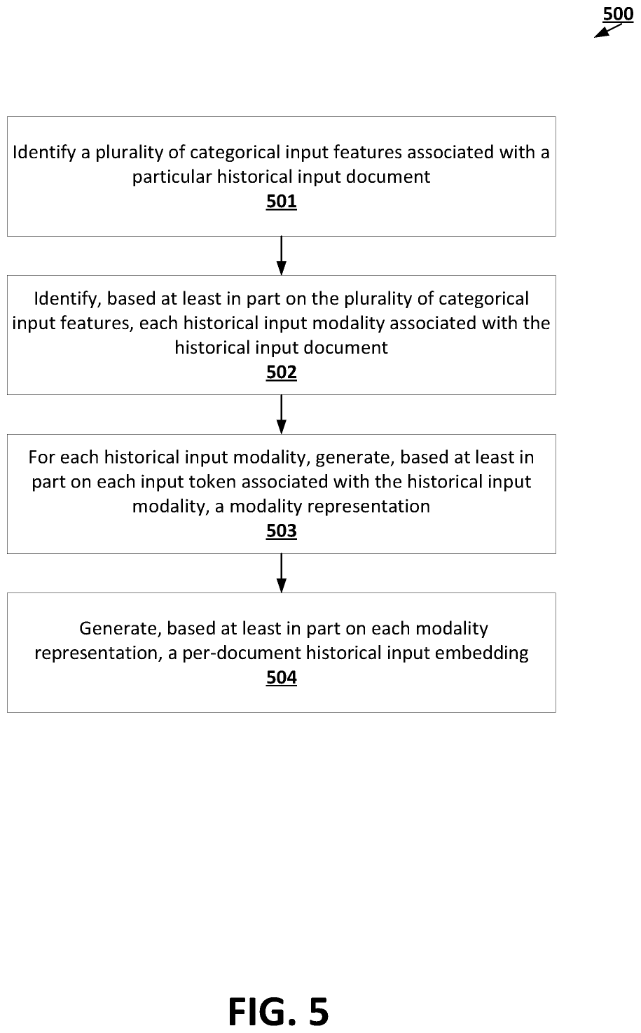

FIG. 5 provides an example process 500 for generating a per-document historical input embedding for a particular historical input document. In some embodiments, the process 500 begins at step/operation 501 when the predictive data analysis computing entity 106 identifies a plurality of categorical input features (e.g., ICD code, CPT code, LOINC code, medication descriptor, treatment code, and/or the like) associated with the particular historical input document. As noted above, in some embodiments, each categorical input feature present in a historical input document may be associated with a historical input modality of a plurality of historical modalities. Additionally, in some embodiments, each categorical input feature present in a historical input document may be associated with a per-modality segment of a plurality of modality segments associated with the historical input document.

At step/operation 502, the predictive data analysis computing entity 106 identifies, based at least in part on the plurality of categorical input features (e.g., identified in step/operation 501), each historical input modality associated with the historical input document. In the clinical guideline search context, for example, consider where a historical input document associated with the patient predictive entity comprises ICD code 4321, ICD code 2222, CPT code 3465, and LOINC code 3212. In the noted example, the predictive data analysis computing entity 106 may associate ICD codes 4321 and 2222 with diagnosis historical input modality, associate CPT code 3465 with procedure historical input modality, and associate LOINC code 3212 with laboratory test result historical input modality. Accordingly, in the noted example, the predictive data analysis computing entity 106 may determine that the particular historical input document is associated with diagnosis historical input modality, procedure historical input modality, and laboratory test result historical input modality. In some embodiments, the predictive data analysis computing entity 106 may be configured to associate a categorical input feature with a corresponding historical input modality using one or more models of the multimodal hierarchical attention machine learning framework.

Additionally and/or alternatively, in some embodiments, the historical input modalities associated with the historical input document may be determined based at least in part on the per-modality segments of the historical input document. For example, in some embodiments, determining historical modalities associated with a predictive input entity may comprise processing each per-modality segment of the historical input document to determine the presence of at least one categorical input feature in the respective per-modality segment.

At step/operation 503, for each historical input modality associated with the historical input document (e.g., identified in step/operation 502), the predictive data analysis computing entity 106 generates, based at least in part on each input token associated with the historical input modality, a modality representation for the respective historical input modality. As noted above, in some embodiments, the multimodal hierarchical attention machine learning framework includes a plurality of per-modality cross-token attention machine learning models that are each associated with a particular historical input modality. In some embodiments, the predictive data analysis computing entity 106 may generate the modality representation for each historical input modality based at least in part on each input token associated with the historical input modality using the per-modality cross-token attention machine learning model for the historical input modality. In some embodiments, the attention mechanism of a per-modality cross-token attention machine learning model generates a context-based vector representation of a historical input modality based at least in part on a set of attention weights associated with the per-modality cross-token attention machine learning model. In some embodiments, each attention weight is associated with a pair of input tokens (e.g., word tokens) that are both associated with a common attention window, and describes a predicted semantic relationship significance of the pair of input tokens.

In some embodiments, for each historical input modality, the corresponding per-modality cross-token attention machine learning model for the respective historical input modality may be configured to receive each input token associated with the historical input modality as input and process the input tokens in accordance with an attention mechanism to generate the modality representation for the respective historical input modality. For example, each per-modality cross-token attention machine learning model may be configured to generate a modality representation for a subset of P input tokens of a historical input document that are associated with a historical input modality of the corresponding per-modality cross-token attention machine learning model using an attention mechanism associated with a defined attention window size.

In some embodiments, for each identified historical input modality for a historical input document, the input tokens provided as inputs to a per-modality cross-token attention machine learning model comprise each individual categorical input feature of the historical input document having a historical input modality associated with the per-modality cross-token attention machine learning model, where the corresponding per-modality cross-token attention machine learning model may be configured to process the individual categorical input features in accordance with an attention mechanism to generate a modality representation for the respective historical input modality. For example, continuing with the clinical guideline search context example, consider where a historical input document associated with the patient predictive entity comprises: (i) ICD diagnosis codes 4321, 4567 and 2222, and (ii) CPT procedure codes 3465, 2424, 1111, 4444. In the noted example, a first per-modality cross-token attention machine learning model for diagnosis historical input modality may receive the ICD diagnosis codes 4321, 4567, and 2222, and process each of the three diagnosis codes in accordance with an attention mechanism to generate a contextual modality representation of the diagnosis codes. Additionally, a second per-modality cross-token attention machine learning model for procedure historical input modality may receive the CPT procedure codes 3465, 2424, 1111, 4444, and process each of the four procedure codes in accordance with an attention mechanism to generate a modality representation of the procedure codes. In some embodiments, in addition to providing categorical input features as input to the corresponding per-modality cross-token attention machine learning model, the temporal information (e.g., date and/or time) associated with each categorical input feature and/or the corresponding historical input document is provided as input to the per-modality cross-token attention machine learning model to generate, based at least in part on the categorical input features and the temporal information, a contextual modality representation that incorporates temporal information.

In some embodiments, the input tokens provided as input to a per-modality cross-token attention machine learning model comprise each individual categorical input feature of the historical input document having a historical input modality associated with the per-modality cross-token attention machine learning model, as well as one or more of: (i) temporal information associated with each categorical input feature, and/or (ii) text data associated with the categorical input features. In some embodiments, the text data may comprise text data determined from the historical input document. Additionally and/or alternatively, in some embodiments, the text data may comprise text descriptors associated with each categorical input feature. For example, continuing with the noted clinical guideline search context example, consider where a historical input document includes treatment code “1234” associated with text descriptor “diabetes, type-2,” treatment code “1235” associated with text descriptor “diabetes, type-1,” prescription code “5678” associated with text descriptor “metformin-first line treatment for type-2 diabetes,” and prescription code “5679” associated with text descriptor “insulin-first line treatment for type-1 diabetes.” In the noted example, the predictive data analysis computing entity 106 may: (i) identify code “1234” as a treatment code and associate code “1234” with the corresponding text descriptor “diabetes, type-2,” (ii) identify code “1235” as a treatment code and associate code “1235” with the corresponding text descriptor “diabetes, type-1,” (iii) identify code “5678” as a prescription code and associate code “5678” with the corresponding text descriptor “metformin-first line treatment for type-2 diabetes,” and (iv) identify code “5679” as a prescription code and associate code “5679” with the corresponding text descriptor “insulin-first line treatment for type-1 diabetes.”

In the noted example, the inputs to the per-modality cross-token attention machine learning model for treatment historical input modality may include treatment code “1234,” treatment code “1235,” text descriptor “diabetes, type-2,” and text descriptor “diabetes, type-1.” Additionally, in the noted example, the inputs to the per-modality cross-token attention machine learning model for prescription historical input modality may include prescription code “5678,” prescription code “5679,” text descriptor “metformin-first line treatment for type-2 diabetes,” and text descriptor “insulin-first line treatment for type-1 diabetes.” Additionally, in the noted example, the inputs to the per-modality cross-token attention machine learning model for treatment historical input modality and the inputs to the per-modality cross-token attention machine learning model for prescription historical input modality may include the data and/or time associated with each categorical input feature and/or the historical input document (e.g., date and/or time of the medical visit).

At step operation 504, the predictive data analysis computing entity, based at least in part on each modality representation (e.g. generated in step/operation 503) generates the per-document historical input embedding. As noted above, in some embodiments, the multimodal hierarchical attention machine learning framework includes a cross-modality attention machine learning model. In some embodiments, the predictive data analysis computing entity 106 may generate the per-document historical input embedding based at least in part on each modality representation for the identified historical input modalities using the cross-modality attention machine learning model of the multimodal hierarchical attention machine learning framework. In some embodiments, generating the per-document historical input embedding may comprise combining (e.g., aggregating, concatenating, summing, averaging, computing product, and/or the like) each modality representation generated for the historical input document. For example in some embodiments, for each historical input document, the generated per-document historical input embedding may be a product of each modality representation generated for the historical input document.

### Generating Historical Input Embedding

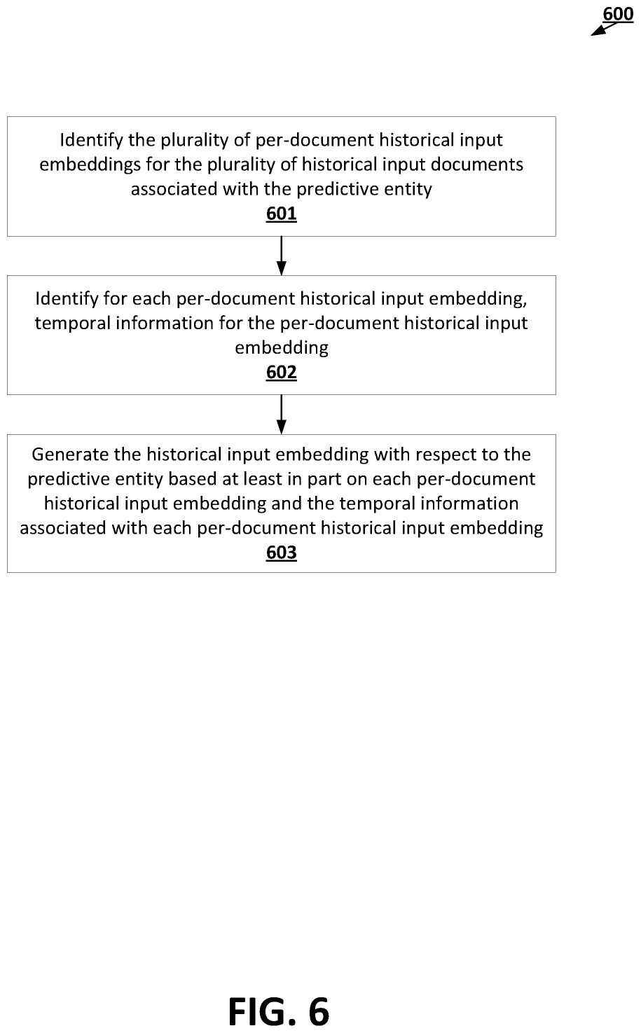

FIG. 6 illustrates an example process 600 of generating a historical input embedding with respect to a predictive entity. The process 600 that is depicted in FIG. 6 begins at step/operation 601 when the predictive data analysis computing entity 106 identifies the plurality of per-document historical input embeddings for the plurality of historical input documents associated with the predictive entity (e.g., fixed-size vector representation of each identified historical input document associated with the predictive entity that is generated in step/operation 504). As described above, in some embodiments, each historical input document may be associated with temporal information (e.g., date and/or time). Moreover, in various embodiments, each generated per-document historical input embedding may be associated with a temporal information (e.g., date and/or time) for the corresponding historical input document.

At step/operation 602, the predictive data analysis computing entity 106 identifies for each per-document historical input embedding, temporal information for the per-document historical input embedding. At step/operation 603, the predictive data analysis computing entity 106 generates, based at least in part on each per-document historical input embedding and the identified temporal information associated with each per-document historical input embedding and using a cross-temporal attention machine learning model of the multimodal hierarchical attention machine learning framework, a historical input embedding for the predictive entity, where the historical input embedding describes a fixed-size contextual vector representation of each identified historical document associated with the predictive entity, incorporating the corresponding temporal information. For example, the cross-temporal attention machine learning model may be configured to receive (e.g., from the predictive data analysis computing entity 106) each generated per-document historical input embedding along with the associated temporal information, and process the per-document historical input embeddings along with the associated temporal information in accordance with an attention mechanism to generate a historical input embedding for the predictive entity. In some embodiments, processing the per-document historical input embeddings along with the associated temporal information may comprise processing weighted per-document historical input embeddings. For example, in some embodiments, each per-document historical input embedding may be assigned a weight value based at least in part on the temporal information associated with the per-document historical input embedding relative to other per-document historical input embeddings. For example in some embodiments a first per-document historical input embedding that is associated with a more recent temporal information relative to a second per-document historical input embedding may be assigned a greater weight value relative to the second per-document historical input embedding.

### Generating Reference Embeddings

Returning to FIG. 4, at step/operation 405, the predictive data analysis computing entity 106 generates, based at least in part on (i) the historical input embedding, (ii) the current input embedding, and (iii) a plurality of referential embeddings for a plurality of reference documents, a cross-temporal search result prediction. In some embodiments, the cross-temporal search result prediction describes a ranked list of reference document sections from a selected subset of the plurality of referential embeddings. As noted above, in various embodiments, the plurality of referential embeddings may be stored in a referential embedding repository, where one or more computing entities (e.g., the predictive data analysis computing entity 106) may retrieve the referential embeddings. A reference document may describe a document data object comprising content data (e.g., a collection of one or more words). An example of a reference document is a clinical guideline comprising statements to assist a provider with respect to appropriate action(s) for specific clinical circumstances. In some embodiments, a reference document may comprise one or more reference document sections that comprise a subset of the content data associated with the reference document.

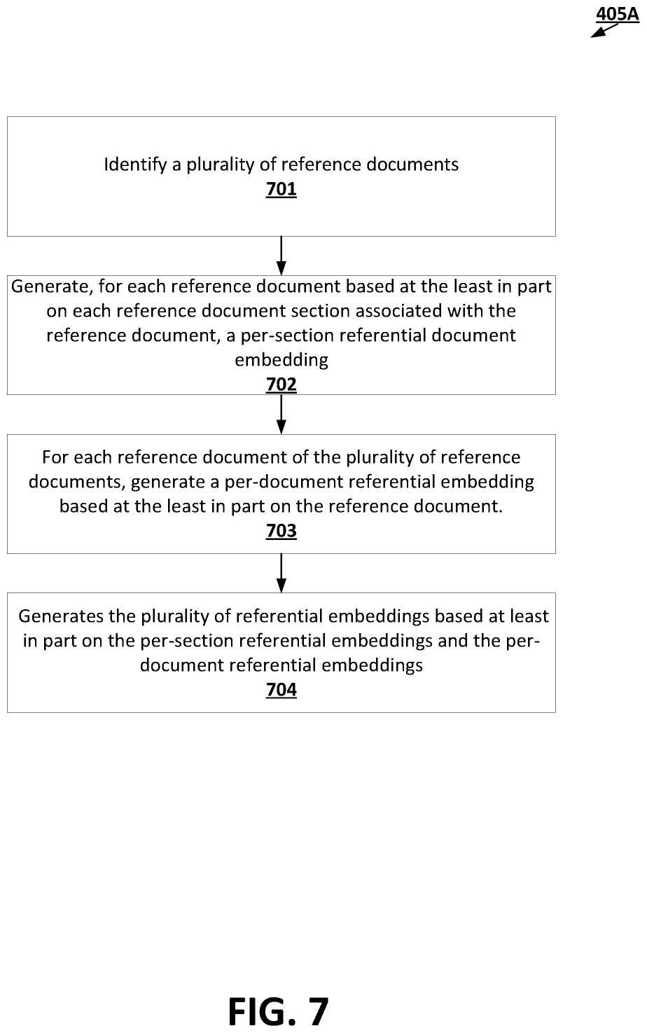

In some embodiments, the plurality of referential embeddings comprise, for each reference document: (i) a per-document referential embedding and (ii) a plurality of per-section referential embeddings for a plurality of reference document sections of the reference document. In some embodiments, the plurality of referential embeddings may be generated in accordance with the process that is depicted in FIG. 7, which is an example process for generating a plurality of referential embeddings. In various embodiments, the plurality of referential embeddings are generated as precursor operation, and the generated plurality of referential embeddings may be stored in a repository and accessible to be utilized for subsequent cross-temporal search result prediction requests. The process that is depicted in FIG. 7 begins at step/operation 701 when the predictive data analysis computing entity 106 identifies a plurality of reference documents.

At step/operation 702, the predictive data analysis computing entity 106 generates, for each reference document of the plurality of reference documents based at the least in part on each reference document section associated with the reference document, a plurality of per-section referential embeddings. A per-section referential embedding may describe a section-wise embedded representation of a particular reference document section that is a fixed size vector representation of all of the text data associated with the particular reference document section. In some embodiments, the per-section referential embeddings for a reference document may be generated utilizing one or more of a variety of techniques (e.g., Word2Vec, Random Projection, Term Frequency—Inverse Document Frequency (TF-IDF), transformers, and/or the like). In some embodiments, the predictive data analysis computing entity 106 generates the per-section referential embeddings for each reference document utilizing one or more models of the multimodal hierarchical attention machine learning framework. For example, in some embodiments, the per-section referential embeddings for each reference document is generated using a cross-section attention machine learning model of the multimodal hierarchical attention machine learning framework that is configured to generate in accordance with an attention mechanism a per-section referential embedding for each reference document section of the respective reference document. In some embodiments, to generate a per-section referential embedding for a particular reference document section, the predictive data analysis computing entity 106 provides each word token associated with the reference document section to the cross-section attention machine learning model, and in response, the cross-section attention machine learning model processes the word tokens in accordance with an attention mechanism to generate a per-section referential embedding that is a context-based section-wise vector representation of all of the word tokens of the reference document section. In some embodiments, the attention mechanism of a cross-token attention machine learning model generates a context-based representation for each reference document section based at least in part on a set of attention weights associated with the cross-token attention machine learning model. In some embodiments, each attention weight is associated with a pair of input tokens (e.g., word token) that are both associated with a common attention window and describes a predicted semantic relationship significance of the pair of input tokens.

At step/operation 703, the predictive data analysis computing entity 106 generates, for each reference document of the plurality of reference documents, a per-document referential embedding based at the least in part on the reference document. A per-document referential embedding of a particular reference document may describe a document-wide embedded representation of the particular reference document that is a fixed-sized vector representation of the text data associated with the reference document.

In some embodiments, the per-document referential embeddings for a reference document may be generated utilizing one or more of a variety of techniques (e.g., Word2Vec, Random Projection, Term Frequency—Inverse Document Frequency (TF-IDF), transformers, and/or the like). In some embodiments, the predictive data analysis computing entity 106 generates the per-document referential embeddings for each reference document utilizing the multimodal hierarchical attention machine learning framework. For example, in some embodiments, the per-document referential embedding for each reference document is generated using a per-document cross-section attention machine learning model of the multimodal hierarchical attention machine learning framework that is configured to generate a per-document referential embedding in accordance with an attention mechanism. In some embodiments, for each reference document, the inputs to the per-document cross-section attention machine learning model are section-wise tokens associated with the plurality of reference document sections of the reference document. In some embodiments, the attention mechanism of a per-document cross-section attention machine learning model generates a context-based representation for a reference document based at least in part on a set of attention weights associated with the per-document cross-token attention machine learning model, where each attention weight is associated with a pair of section-wise input tokens that are both associated with a common attention window and describes a predicted semantic relationship significance of the pair of input tokens.

At step/operation 704, the predictive data analysis computing entity 106 generates the plurality of referential embeddings, where, as noted above, the plurality of referential embeddings comprise, for each reference document, the generated per-document referential embedding and the generated plurality of per-section referential embeddings for the plurality of reference document sections of the reference document.

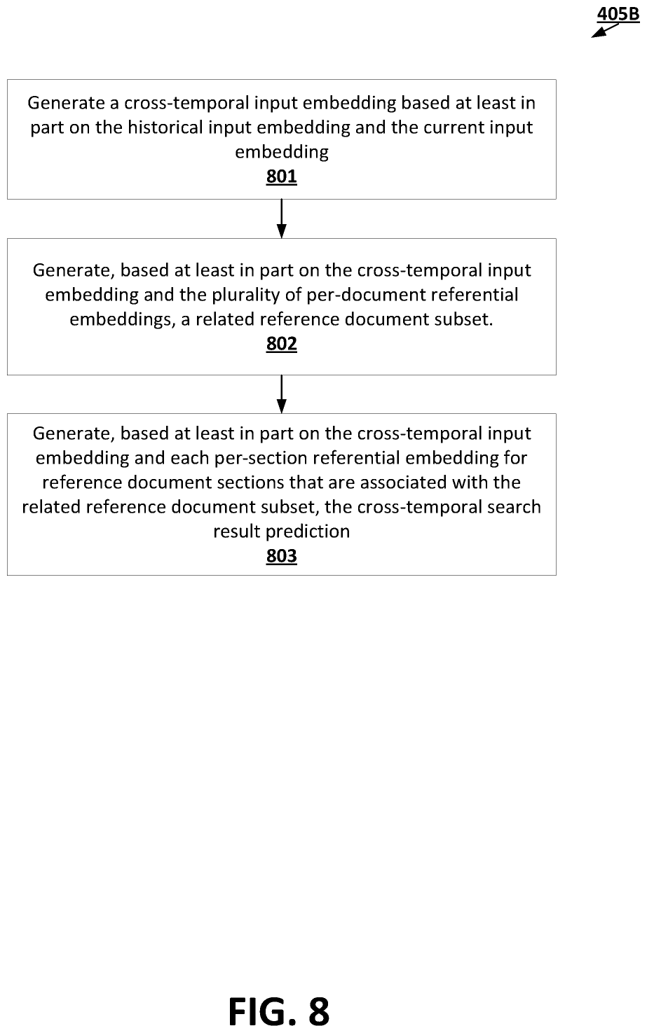

Returning to FIG. 4, at step/operation 405, in some embodiments, step/operation 405 may be performed in accordance with the process that is depicted in FIG. 8, which is an example process for generating a cross-temporal search result prediction. The process that is depicted in FIG. 8 begins at step/operation 801 when the predictive data analysis computing entity 106 generates a cross-temporal input embedding based at least in part on the historical input embedding and the current input embedding. The cross-temporal input embedding may describe a search query vector, which may in turn be used to identify one or more relevant reference documents and/or one or more relevant portions of reference documents. For example, continuing with the noted clinical guideline search context example, the cross-temporal input embedding may be used to identify relevant clinical guidelines and/or relevant portions of clinical guidelines that may serve as a tool to assist the corresponding provider in providing proper diagnosis, providing proper treatment, determining actions to take, and/or the like with respect to the patient predictive entity.

The cross-temporal input embedding may be generated utilizing a variety of techniques. For example, in some embodiments, the cross-temporal input embedding may be generated utilizing a machine learning model (e.g., BERT). In some embodiments, one or more models of the multimodal hierarchical attention machine learning framework may be used to generate the cross-temporal input embedding based at least in part on the historical input embedding and the current input embedding. In some embodiments, the cross-temporal input embedding may be generated by combining (e.g., aggregating, concatenating, summing, averaging, computing product, and/or the like) the current input embedding and the historical input embedding to generate the cross-temporal input embedding. In some embodiments a supervised learning algorithm may be configured to determine the best technique/method for generating the cross-temporal input embedding.

At step/operation 802, the predictive data analysis computing entity 106 generates, based at least in part on the cross-temporal input embedding and the plurality of per-document referential embeddings for the plurality of reference documents, a related reference document subset. A related reference document subset may describe one or more reference documents from the plurality of reference documents, each having a per-document referential embedding that is deemed to be similar to the cross-temporal input embedding based at least in part on a per-document embedding similarity measure associated with the respective per-document referential embedding. A per-document embedding similarity measure may describe a computed/predicted similarity measure (e.g., similarity score) between a cross-temporal input embedding associated with a predictive entity and a per-document referential embedding of a particular reference document. In some embodiments, given a cross-temporal input embedding and a per-document referential embedding, the per-document similarity measure for the embedding pair may be generated based at least in part on a distance/similarity measure (e.g., a cosine distance measure, a cosine distance similarity measure, a cosine similarity measure, and/or the like) of the cross-temporal input embedding and the per-document referential embedding. In some embodiments, the per-document similarity measure for the embedding pair (the cross-temporal input embedding and the per-document referential embedding) may be generated using neural ranking with weak supervision technique.

In some embodiments, to generate the related reference document subset, the predictive data analysis computing entity 106 determines reference documents from the plurality of reference documents having a per-document embedding similarity measure relative to the cross-temporal input embedding that satisfies a similarity measure threshold (e.g., greater than a defined similarity measure/similarity score, greater than and/or equal to a defined similarity measure/similarity score, and/or the like). In some embodiments, to generate the related reference document subset, the predictive data analysis computing entity 106: (i) generates a ranked/ordered list of reference documents by ranking each reference document based at least in part on the per-document similarity measure for the per-document reference embedding of the reference document, where each reference document is associated with a rank/order position; and (ii) generates a defined-size related reference document subset based at least in part on the rank/order position of each reference document in the ranked/ordered list of reference documents, where the defined-size related reference document subset comprises the top-N-ranked document references (where N represents the defined size (e.g., 5, 10, 15, and/or the like)).

At step/operation 803, the predictive data analysis computing entity 106 generates the cross-temporal search result prediction based at least in part on the cross-temporal input embedding and each per-section referential embedding for reference document sections that are associated with the defined-size related reference document subset (e.g., each per-section referential embedding for each reference document section of the reference documents in the defined-size related reference document subset). As noted above, the cross-temporal search result prediction describes a ranked list of reference document sections from a selected subset of the plurality of referential embeddings. For example, the cross-temporal search result prediction may comprise a ranked list of reference document sections associated with the related reference document subset (e.g., defined-size related reference document subset).

In some embodiments, to generate the cross-temporal search result prediction based at least in part on the cross-temporal input embedding and each per-section referential embedding for reference document sections that are associated with the defined-size related reference document subset, the predictive data analysis computing entity 106, generates, for each per-section referential embedding for reference document sections that are associated with the related reference document subset (e.g., defined-size related reference document subset), a per-section embedding similarity measure. A per-section embedding similarity measure may describe a computed/predicted similarity measure (e.g., similarity score) between a cross-temporal input embedding associated with a predictive entity and a per-section referential embedding for a reference document section that is associated with the related reference document subset. In some embodiments, given a cross-temporal input embedding and a per-section referential embedding for a reference document section that is associated with the defined-size related reference document subset, the per-section similarity measure for the embedding pair may be generated based at least in part on a distance/similarity measure (e.g., a cosine distance measure, a cosine distance similarity measure, a cosine similarity measure, and/or the like) of the cross-temporal input embedding and the per-section referential embedding. In some embodiments, the per-section similarity measure for the embedding pair (e.g., cross-temporal input embedding and the per-section referential embedding for the reference document section that is associated with the defined-size related reference document subset) may be generated using neural ranking with weak supervision technique.

Accordingly, the cross-temporal search result prediction may comprise a ranked list of reference document sections that are deemed to be the most relevant reference document sections relative to the cross-temporal input embedding (e.g., search query vector). For example, continuing with the clinical guideline search context example, the cross-temporal input embedding may comprise a ranked list of clinical guideline sections that are deemed to be the most relevant guideline sections relative to the contextualized cross-temporal input embedding (e.g., search query vector).

In some embodiments, the ordering/ranking of the ranked list of reference document sections (e.g., the cross-temporal search result prediction) may be a learned ranking function, where metrics such as the reference document sections that the providers select and the amount of time a provider spends on each selected reference document section serves as indicators of the degree to which a reference document section is relevant to the provider's search. In some embodiments, the noted metrics may be used as ground-truth labels in training data to adjust the vector representations/embedding of text data, weighting of current input embeddings relative to historical input embeddings, and measurement of the similarity measures (e.g., per-document similarity measures and per-section similarity measures) to better rank/order search results (e.g., cross-temporal search result prediction) according to their relevance to providers.

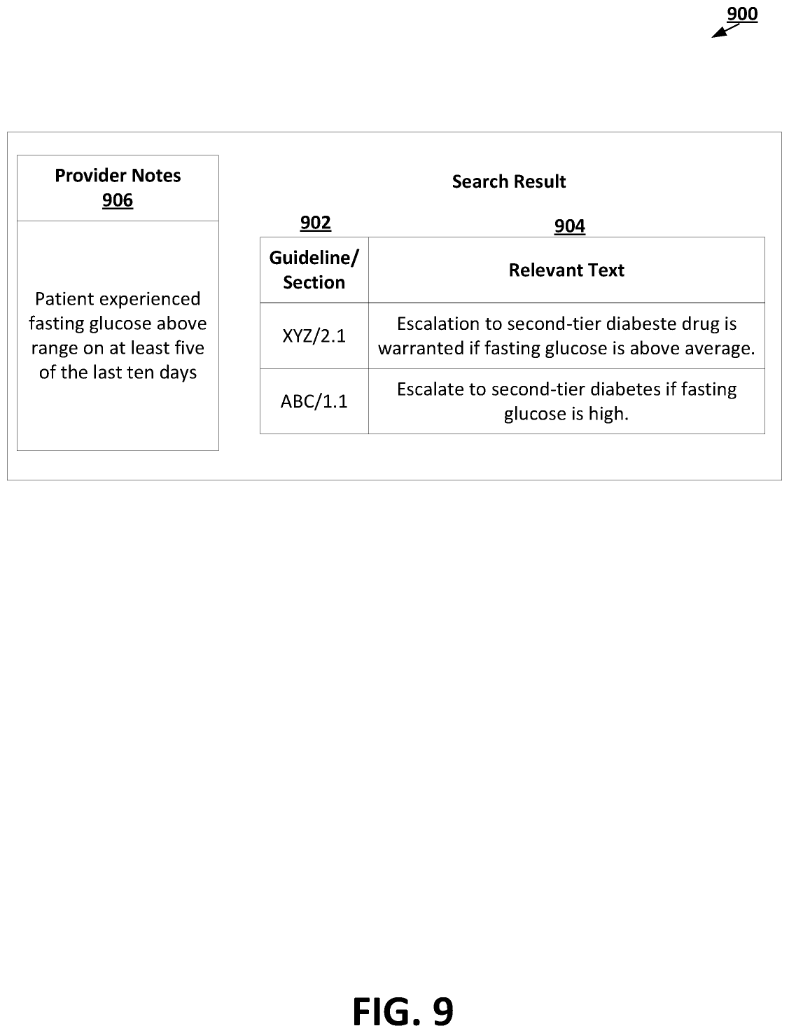

Returning to FIG. 4, at step/operation 406, the predictive data analysis computing entity 106 performs one or more prediction-based actions based at least in part on the cross-temporal search result prediction. In some embodiments, performing the one or more prediction-based actions comprises generating user data for a prediction output user interface that displays the selected reference document sections associated with the cross-temporal search result prediction. An operational example of such a prediction output user interface 900 is depicted in FIG. 9. As shown in FIG. 9, the user interface may be configured to display the reference document sections (e.g., clinical guideline sections) 904 associated with the cross-temporal search result prediction (e.g., the top-ranked reference document sections) along with corresponding identifier 902 for the reference document section. In some embodiments, pertinent portions of the reference document section may be highlighted. Additionally, in some embodiments, the user interface may be configured to display the provider notes 906 with respect to which the cross-temporal search result prediction was generated.

Moreover, an example of a prediction-based action that can be performed in accordance with various embodiments of the present invention relates to performing operational load balancing for post-prediction systems by using cross-temporal search result classifications generated based at least in part on cross-temporal search result predictions to determine an optimal number of computing entities needed to perform the noted post-processing operations. For example, in some embodiments, a predictive data analysis computing entity determines L cross-temporal search result classifications for L predictive entities based at least in part on the cross-temporal search result predictions for the predictive entities. Then, the count of predictive entities that are associated with affirmative cross-temporal search result classifications, along with a resource utilization ratio for each predictive entity, can be used to predict a predicted number of computing entities needed to perform post-prediction processing operations (e.g., automated investigation operations) with respect to the L predictive entities. For example, in some embodiments, the number of computing entities needed to perform post-prediction processing operations (e.g., automated investigation operations) with respect to the L predictive entities can be determined based at least in part on the output of the equation: R=ceil(Σₖ^{k=K}urₖ), where R is the predicted number of computing entities needed to perform post-prediction processing operations with respect to the L predictive entities, cell(⋅) is a ceiling function that returns the closest integer that is greater than or equal to the value provided as the input parameter of the ceiling function, k is an index variable that iterates over K predictive entities among the L predictive entities that are associated with affirmative cross-temporal search result classifications, and urₖ is the estimated resource utilization ratio for a kth predictive entity that may be determined based at least in part on an input batch size associated with the kth predictive entity. In some embodiments, once R is generated, the predictive data analysis computing entity can use R to perform operational load balancing for a server system that is configured to perform post-prediction processing operations (e.g., automated investigation operations) with respect to the L predictive entities. This may be done by allocating computing entities to the post-prediction processing operations if the number of currently-allocated computing entities is below R, and deallocating currently-allocated computing entities if the number of currently-allocated computing entities is above R.

As describe below, various embodiments of the present disclosure make important technical contributions to improving predictive accuracy of search result generation machine learning models that operate on multi-modality input data by using cross-modality attention machine learning models as part of the encoding mechanism of the noted search result generation machine learning models, an improvement which in turn enhances training speed and training efficiency of machine learning models. It is well-understood in the relevant art that there is typically a tradeoff between predictive accuracy and training speed, such that it is trivial to improve training speed by reducing predictive accuracy, and thus the real challenge is to improve training speed without sacrificing predictive accuracy through innovative model architectures, see, e.g., Sun et al., Feature-Frequency—Adaptive On-line Training for Fast and Accurate Natural Language Processing in 40(3) Computational Linguistic 563 at Abst. (“Typically, we need to make a tradeoff between speed and accuracy. It is trivial to improve the training speed via sacrificing accuracy or to improve the accuracy via sacrificing speed. Nevertheless, it is nontrivial to improve the training speed and the accuracy at the same time”). Accordingly, the techniques described herein improve predictive accuracy without harming training speed, such as various techniques described herein, enable improving training speed given a constant predictive accuracy. In doing so, the techniques described herein improve accuracy, efficiency, and speed of search result generation machine learning models, thus reducing the number of computational operations needed and/or the amount of training data entries needed to train search result generation machine learning models. Accordingly, the techniques described herein improve at least one of the computational efficiency, storage-wise efficiency, and speed of training search result generation machine learning models.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for generating a cross-temporal search result prediction for a predictive entity, the computer-implemented method comprising:
identifying, using one or more processors, a current input document and a plurality of historical input documents associated with the predictive entity, wherein each historical input document comprises a plurality of per-modality segments for a plurality of historical input modalities;
generating, using the one or more processors, a historical input embedding for the predictive entity based at least in part on the plurality of historical input documents, wherein: (i) the historical input embedding is generated based at least in part on a plurality of per-document historical input embeddings for the plurality of historical input documents, and (ii) generating a respective per-document historical input embedding for a particular historical input document comprises:
for each historical input modality, generating, based at least in part on each input token that is associated with the historical input modality using the one or more processors and using a per-modality cross-token attention machine learning model for the historical input modality, a modality representation, and
generating, based at least in part on each modality representation using the one or more processors and a cross-modality attention machine learning model, the respective per-document historical input embedding;
generating, using the one or more processors and based at least in part on the historical input embedding, a current input embedding for the historical input embedding, and a plurality of referential embeddings for a plurality of reference documents, the cross-temporal search result prediction; and
performing, using the one or more processors, one or more prediction-based actions based at least in part on the cross-temporal search result prediction.

2. The computer-implemented method of claim 1, wherein the plurality of referential embeddings comprise, for each reference document, a per-document referential embedding and a plurality of per-section referential embeddings for a plurality of reference document sections of the reference document.

3. The computer-implemented method of claim 2, wherein the plurality of per-section referential embeddings are generated based at least in part on the plurality of reference document sections and using a cross-section attention machine learning model.

4. The computer-implemented method of claim 2, wherein generating the cross-temporal search result prediction comprises:
generating a cross-temporal input embedding based at least in part on the historical input embedding and the current input embedding;
generating, based at least in part on the cross-temporal input embedding and a plurality of per-document referential embeddings for the plurality of reference documents, a defined-size related reference document subset of the plurality of reference documents; and
generating, based at least in part on the cross-temporal input embedding and each per-section referential embedding for reference document sections that are associated with the defined-size related reference document subset, the cross-temporal search result prediction.

5. The computer-implemented method of claim 1, wherein the plurality of historical input modalities are defined by a modality taxonomy that is shared across the plurality of historical input documents.

6. The computer-implemented method of claim 1, wherein the cross-modality attention machine learning model is a bidirectional transformer model.

7. The computer-implemented method of claim 1, wherein the cross-temporal search result prediction describes a ranked list of reference document sections from a selected subset of the plurality of referential embeddings.

8. An apparatus for generating a cross-temporal search result prediction for a predictive entity, the apparatus comprising at least one processor and at least one memory including program code, the at least one memory and the program code configured to, with the processor, cause the apparatus to at least:
identify a current input document and a plurality of historical input documents associated with the predictive entity, wherein each historical input document comprises a plurality of per-modality segments for a plurality of historical input modalities;
generate a historical input embedding for the predictive entity based at least in part on the plurality of historical input documents, wherein: (i) the historical input embedding is generated based at least in part on a plurality of per-document historical input embeddings for the plurality of historical input documents, and (ii) generating a respective per-document historical input embedding for a particular historical input document comprises:
for each historical input modality, generating, based at least in part on each input token that is associated with the historical input modality and using a per-modality cross-token attention machine learning model for the historical input modality, a modality representation, and
generating, based at least in part on each modality representation and using a cross-modality attention machine learning model, the respective per-document historical input embedding;
generate, based at least in part on the historical input embedding, a current input embedding for the historical input embedding, and a plurality of referential embeddings for a plurality of reference documents, the cross-temporal search result prediction; and
perform one or more prediction-based actions based at least in part on the cross-temporal search result prediction.

9. The apparatus of claim 8, wherein the plurality of referential embeddings comprise, for each reference document, a per-document referential embedding and a plurality of per-section referential embeddings for a plurality of reference document sections of the reference document.

10. The apparatus of claim 9, wherein the plurality of per-section referential embeddings are generated based at least in part on the plurality of reference document sections and using a cross-section attention machine learning model.

11. The apparatus of claim 9, wherein generating the cross-temporal search result prediction comprises:
generating a cross-temporal input embedding based at least in part on the historical input embedding and the current input embedding;
generating, based at least in part on the cross-temporal input embedding and a plurality of per-document referential embeddings for the plurality of reference documents, a defined-size related reference document subset of the plurality of reference documents; and
generating, based at least in part on the cross-temporal input embedding and each per-section referential embedding for reference document sections that are associated with the defined-size related reference document subset, the cross-temporal search result prediction.

12. The apparatus of claim 8, wherein the plurality of historical input modalities are defined by a modality taxonomy that is shared across the plurality of historical input documents.

13. The apparatus of claim 8, wherein the cross-modality attention machine learning model is a bidirectional transformer model.

14. The apparatus of claim 8, wherein the cross-temporal search result prediction describes a ranked list of reference document sections from a selected subset of the plurality of referential embeddings.

15. A computer program product for generating a cross-temporal search result prediction for a predictive entity, the computer program product comprising at least one non-transitory computer-readable storage medium having computer-readable program code portions stored therein, the computer-readable program code portions configured to:
identify a current input document and a plurality of historical input documents associated with the predictive entity, wherein each historical input document comprises a plurality of per-modality segments for a plurality of historical input modalities;
generate a historical input embedding for the predictive entity based at least in part on the plurality of historical input documents, wherein: (i) the historical input embedding is generated based at least in part on a plurality of per-document historical input embeddings for the plurality of historical input documents, and (ii) generating a respective per-document historical input embedding for a particular historical input document comprises:
for each historical input modality, generating, based at least in part on each input token that is associated with the historical input modality and using a per-modality cross-token attention machine learning model for the historical input modality, a modality representation, and
generating, based at least in part on each modality representation and using a cross-modality attention machine learning model, the respective per-document historical input embedding;
generate, based at least in part on the historical input embedding, a current input embedding for the historical input embedding, and a plurality of referential embeddings for a plurality of reference documents, the cross-temporal search result prediction; and
perform one or more prediction-based actions based at least in part on the cross-temporal search result prediction.

16. The computer program product of claim 15, wherein the plurality of referential embeddings comprise, for each reference document, a per-document referential embedding and a plurality of per-section referential embeddings for a plurality of reference document sections of the reference document.

17. The computer program product of claim 16, wherein the plurality of per-section referential embeddings are generated based at least in part on the plurality of reference document sections and using a cross-section attention machine learning model.

18. The computer program product of claim 16, wherein generating the cross-temporal search result prediction comprises:
generating a cross-temporal input embedding based at least in part on the historical input embedding and the current input embedding;
generating, based at least in part on the cross-temporal input embedding and a plurality of per-document referential embeddings for the plurality of reference documents, a defined-size related reference document subset of the plurality of reference documents; and
generating, based at least in part on the cross-temporal input embedding and each per-section referential embedding for reference document sections that are associated with the defined-size related reference document subset, the cross-temporal search result prediction.

19. The computer program product of claim 15, wherein the plurality of historical input modalities are defined by a modality taxonomy that is shared across the plurality of historical input documents.

20. The computer program product of claim 15, wherein the cross-modality attention machine learning model is a bidirectional transformer model.
